(19) United States
(12) Patent Application Publication
(10) Pub. No.: US 2018/0131016 A1
(43) Pub. Date: May 10, 2018

(54) METAL BEAD SEAL TUNNEL ARRANGEMENT

(71) Applicant: GM GLOBAL TECHNOLOGY OPERATIONS LLC, Detroit, MI (US)

(72) Inventors: Xi Yang, Bloomfoeld Hills, MI (US); Siguang Xu, Rochester Hills, MI (US); Liang Xi, Northville, MI (US)

(21) Appl. No.: 15/344,655

(22) Filed: Nov. 7, 2016

(51) Int. Cl. H01M 8/0258; H01M 8/0282

(52) U.S. Cl. CPC H01M 8/0258; H01M 8/0282

(57) ABSTRACT

A fuel cell includes a first bipolar plate, a second bipolar plate and a gas diffusion layer. The first bipolar plate defines a first metal bead seal and a first plate embossment in fluid communication with the first metal bead seal. The second bipolar plate defines a second metal bead seal and a second plate embossment in fluid communication with the second metal bead seal. The first plate embossment and the second plate embossment are offset from one another along the length of the first and second metal bead seals. The second metal bead seal is operatively configured to abut the first metal bead seal to form a joint between the first and second bipolar plate. The gas diffusion layer may be disposed between the first bipolar plate and the second bipolar plate.

### TECHNICAL FIELD

This present disclosure relates generally to PEM fuel cells and more particularly to bipolar plates for separating adjacent fuel cells in a fuel cell stack.

### BACKGROUND

Fuel cells have been used as a power source in many applications. For example, fuel cells have been proposed for use in electrical vehicular power plants to replace internal combustion engines. In proton exchange membrane (PEM) type fuel cells, hydrogen is supplied to the anode of the fuel cell and oxygen is supplied as the oxidant to the cathode. PEM fuel cells include a membrane electrode assembly (MEA) comprising a thin, proton transmissive, non-electrically conductive, solid polymer electrolyte membrane having the anode catalyst on one face and the cathode catalyst on the opposite face. The MEA is sandwiched between a pair of non-porous, electrically conductive elements or plates which (1) pass electrons from the anode of one fuel cell to the cathode of the adjacent cell of a fuel cell stack, (2) contain appropriate channels and/or openings formed therein for distributing the fuel cell's gaseous reactants over the surfaces of the respective anode and cathode catalysts; and (3) contain appropriate channels and/or openings formed therein for distributing appropriate coolant throughout the fuel cell stack in order to maintain temperature.

The term “fuel cell” is typically used to refer to either a single cell or a plurality of cells (stack) depending on the context. A plurality of individual cells are typically bundled together to form a fuel cell stack and are commonly arranged in electrical series. Each cell within the stack includes the membrane electrode assembly (MEA) described earlier, and each such MEA provides its increment of voltage. A group of adjacent cells within the stack is referred to as a cluster. By way of example, some typical arrangements for multiple cells in a stack are shown and described in U.S. Pat. No. 5,663,113. In PEM fuel cells, hydrogen (H2) is the anode reactant (i.e., fuel) and oxygen is the cathode reactant (i.e., oxidant). The oxygen can be either a pure form (O₂) or air (a mixture of O2 and N2).

The electrically conductive plates sandwiching the MEAs may contain an array of grooves in the faces thereof that define a reactant flow field for distributing the fuel cell's gaseous reactants (i.e., hydrogen and oxygen in the form of air) over the surfaces of the respective cathode and anode. These reactant flow fields generally include a plurality of lands that define a plurality of flow channels therebetween through which the gaseous reactants flow from a supply header at one end of the flow channels to an exhaust header at the opposite end of the flow channels. The reactant flow field is predetermined flow field pattern directly adjacent to a face of the gas diffusion layer to encourage a reaction between.

In a fuel cell stack, a plurality of cells are stacked together in electrical series while being separated by a gas impermeable, electrically conductive bipolar plate. In some instances, the bipolar plate is an assembly formed by securing a pair of thin metal sheets having reactant flow fields formed on their external face surfaces. Typically, an internal coolant flow field is provided between the metal plates of the bipolar plate assembly. It is also known to locate a spacer plate between the metal plates to optimize the heat transfer characteristics for improved fuel cell cooling.

Typically, the cooling system associated with a fuel cell stack includes a circulation pump for circulating a liquid coolant through the fuel cell stack to a heat exchanger where the waste thermal energy (i.e., heat) is transferred to the environment. The thermal properties of typical liquid coolants require that a relatively large volume be circulated through the system to reject sufficient waste energy in order to maintain the temperature of the stack within an acceptable range, particularly under maximum power conditions.

Fuel cells have been proposed as a clean, efficient, and environmentally responsible power source for electric vehicles and various other applications. In particular, fuel cells have been identified as a potential alternative for the traditional internal-combustion engine used in modern automobiles.

A common type of fuel cell is known as a proton exchange membrane (PEM) fuel cell. The PEM fuel cell includes a unitized electrode assembly (UEA) disposed between a pair of fuel cell plates such as bipolar plates, for example. The UEA may include diffusion mediums (also known as a gas diffusion layer) disposed adjacent to an anode face and a cathode face of a membrane electrolyte assembly (MEA). The MEA includes a thin proton-conductive, polymeric, membrane-electrolyte having an anode electrode film formed on one face thereof, and a cathode electrode film formed on the opposite face thereof. In general, such membrane-electrolytes are made from ion-exchange resins, and typically comprise a perfluoronated sulfonic acid polymer such as NAFION™ available from the E.I. DuPont de Nemeours & Co. The anode and cathode films, on the other hand, typically comprise (1) finely divided carbon particles, very finely divided catalytic particles supported on the internal and external surfaces of the carbon particles, and proton conductive material (e.g., NAFION™) intermingled with the catalytic and carbon particles, or (2) catalytic particles, sans carbon, dispersed throughout a polytetrafluoroethylene (PTFE) binder.

The MEA may be sandwiched between sheets of porous, gas-permeable, conductive material which press against the anode and cathode faces of the MEA and serve as (1) the primary current collectors for the anode and cathode, and (2) mechanical support for the MEA. Suitable such primary current collector sheets or gas diffusion mediums may comprise carbon or graphite paper or cloth, fine mesh noble metal screen, and the like, as is well known in the art.

The formed-sandwich is pressed between a pair of electrically conductive plates (hereinafter referred to as “bipolar plates”) 12, 14, 16 which serve as secondary current collectors for collecting the current from the primary current collectors and conducting current between adjacent cells (i.e., in the case of bipolar plates) internally of the stack, and externally of the stack in the case of monopolar plates at the ends of the stack. The bipolar plates each contain at least one so-called “flow field” that distributes the fuel cell's gaseous reactants (e.g., H₂ and O₂/air) over the surfaces of the anode and cathode. The reactant flow field includes a plurality of lands which engage the gas diffusion layer and define therebetween a plurality of flow channels through which the gaseous reactants flow between a supply manifold and an exhaust manifold in the bipolar plates. Serpentine flow channels may, but not necessarily, be used in the flow field 18 and connect the supply and exhaust manifolds only after having made a number of hairpin turns and switch backs such that each leg of the serpentine flow channel borders at least one other leg of the same serpentine flow channel. It is understood that various configurations may be used for the flow channels.

Accordingly, when the electrically conductive plates are joined, the joined surfaces define a flow path for a dielectric cooling fluid. The electrically conductive plates are typically produced from a formable metal that provides suitable strength, electrical conductivity, and corrosion resistance, such as 316 allow stainless steel for example.

The stack, which can contain more than one hundred plates, is compressed and the elements held together by bolts through corners of the stack and anchored to frames at the ends of the stack. In order to militate against undesirable leakage of fluids from between the pairs of plates, a seal is often used. The seal is disposed along a peripheral edge of the pairs of plates. Prior art seals have included the use of an elastomeric material. The seals formed by the elastomeric materials perform adquately for prototyping. However, the cost to implement elastomeric materials makes a use thereof undesirable for full scale production.

Accordingly, it would be desirable in the industry to produce a bead seal arrangement between plates of a fuel cell system wherein the bead seal arrangement and the associated joint prevents leakage of fluids from the fuel cell while minimizing the associated costs, thereby improving the durability of the fuel stack.

### SUMMARY OF THE INVENTION

A fuel cell of the present disclosure includes a first bipolar plate, a second bipolar plate, and a gas diffusion layer. Each of the first and second bipolar plates define a metal bead seal about the perimeter of each bipolar plate and openings (fuel/oxygen manifolds) of each of the first and second bipolar plates. The gas diffusion layer may be disposed between the first bipolar plate and the second bipolar plate. It is understood that first and second sub-gaskets may also be disposed on each side of the gas diffusion layer such that the first and second sub-gaskets are secured between the metal bead seals of each of the first and second bipolar plates. It is understood that each metal bead seal from each of the first and second bi-polar plates may be in fluid communication with associated embossments or tunnels—first plate embossment and second plate embossment—which are spaced along at least a portion of each metal bead seal. The first plate embossment and second plate embossment may each define a plurality of tunnels wherein the tunnels from the first plate embossment are offset from the second plate embossment.

A fuel cell in accordance with the present disclosure includes first and second bipolar plates having first metal bead seal and second metal bead seal. A first plate embossment may be in fluid communication with the first metal bead seal while a second plate embossment may be in fluid communication with the second metal bead seal. —The second metal bead seal is operatively configured to abut the first metal bead seal to form a joint between the first and second bipolar plate. The gas diffusion layer may be disposed between the first bipolar plate and the second bipolar plate.

Accordingly, the present disclosure provides a bead seal arrangement for use between plates of a fuel cell system wherein the bead seal arrangement and the associated joint prevents leakage of fluids from the fuel cell while minimizing the associated costs, thereby improving the durability of the fuel stack.

The invention and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description of preferred embodiments, and best mode, appended claims, and accompanying drawings in which:

FIG. 1 is an expanded, schematic view of a PEM fuel cell stack.

FIG. 2 is an isometric schematic view of a bipolar plate in a first embodiment of the present disclosure.

FIG. 3 is an enlarged schematic view of a metal bead seal and an associated embossment in the first embodiment of the present disclosure.

FIG. 4A is an enlarged schematic view of the intersection of a metal bead seal and an associated “aligned” inlet-outlet embossment of a bipolar plate in the first embodiment of the present disclosure.

FIG. 4B is an enlarged schematic view of the intersection of a metal bead seal and an associated “partially aligned” inlet-outlet embossment of a bipolar plate in the first embodiment of the present disclosure.

FIG. 4C is an enlarged schematic view of the intersection of a metal bead seal and an associated “non-aligned” inlet-outlet embossment of a bipolar plate in the first embodiment of the present disclosure.

FIG. 5 is a schematic plan view of a non-limiting example of a first embodiment of a fuel cell of the present disclosure where the first plate embossment and the second plate embossment are spaced apart and offset from each other.

FIG. 6 is a schematic plan view of a non-limiting example of a first embodiment of a fuel cell of the present disclosure where the first plate embossment and the second plate embossment are adjacent to each other.

FIG. 7 is a schematic plan view of a non-limiting example of a first embodiment of a fuel cell of the present disclosure where the first plate embossment and the second plate embossment are partially offset from each other.

FIG. 8 is an expanded view of a separated bipolar plate in accordance with a second embodiment of the present disclosure where the embossment is in fluid communication with a metal bead seal proximate to the periphery of the bipolar plate.

FIG. 9 is a schematic plan view of a bipolar plate in accordance with a second embodiment of the present disclosure where the embossment is in fluid communication with a metal bead seal proximate to the periphery of the bipolar plate.

FIG. 10 is a cross-sectional, partial schematic view along lines 2-2 of FIG. 11 (with metal bead seal removed) showing the first plate embossment relative to the second plate embossment in accordance with various embodiments of the present disclosure.

FIG. 11 is an isometric, cross-sectional, partial schematic view of a first bipolar plate and a second bipolar plate in accordance with various embodiments of the present disclosure.

FIG. 12 is a cross sectional view of the fuel cell in FIG. 11 along lines 6-6 in FIG. 11.

FIG. 13 is a cross sectional view of the fuel cell in FIG. 11 along lines 7-7 in FIG. 11 where first plate embossment is in fluid communication with first plate metal bead seal.

FIG. 14 is a cross sectional view of the fuel cell in FIG. 11 along lines 8-8 in FIG. 11 where second plate embossment is in fluid communication with second plate metal bead seal.

Like reference numerals refer to like parts throughout the description of several views of the drawings.

### DETAILED DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this invention pertains.

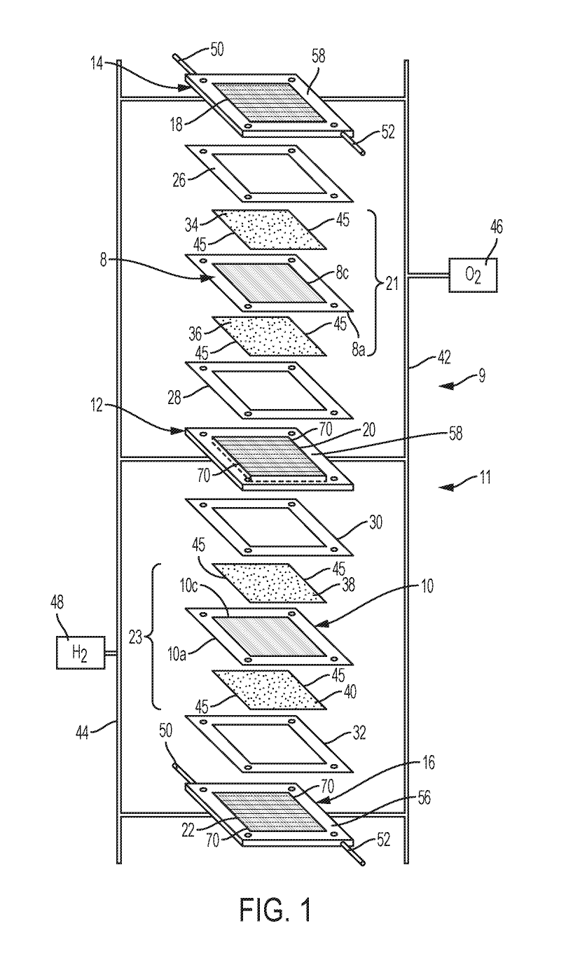

With reference to FIG. 1, a partial PEM fuel cell stack 11 is schematically illustrated. The fuel cell stack 11 includes a pair of membrane-electrode-assemblies (MEAs) 8 and 10 separated from each other by a non-porous, electrically-conductive bipolar plate 12. Each of the MEAs 8, 10 have a cathode face 8c, 10c and an anode face 8a, 10a. The MEAs 8 and 10, are stacked together between non-porous, electrically-conductive, liquid-cooled bipolar plates 14 and 16. The first and second bipolar plates 12, 14 and 16 each include flow fields 18, 20 and 22 formed in the faces of bipolar plates 12, 14, 16 for distributing fuel and oxidant gases (i.e., H₂ & O₂) to the reactive faces of the MEAs 8, 10.

With further reference to FIG. 1, sub-gaskets 26, 28, 30, 32 provide a seal and electrical insulation between the several bipolar plates 12, 14, 16 of the fuel cell stack 11. Porous, gas permeable, electrically conductive sheets (gas diffusion mediums) 34, 36, 38 and 40 press up against the electrode faces of the MEAs 8 and 10 and serve as primary current collectors for the electrodes. As shown in FIG. 1, each sub-gasket 26, 28, 30, 32 defines an internal periphery 41 for the corresponding gas diffusion medium 34, 36, 38, 40. Gas diffusion mediums 34, 36, 38 and 40 also provide mechanical supports for the MEAs 8 and 10, especially at locations where the MEAs are otherwise unsupported in the flow field. Suitable gas diffusion mediums 34, 36, 38, 40 include carbon/graphite paper/cloth, fine mesh noble metal screens, open cell noble metal foams, and the like which conduct current from the electrodes while allowing gas to pass therethrough. However, it is understood that throughout the present disclosure and in the schematic drawings, the gas diffusion layers 21, 23 may actually represent the MEA 8 sandwiched between two gas diffusion mediums as shown in FIG. 1.

It is understood that the gas diffusion layer 21, 23 may be a porous structure made by weaving carbon fibers into a carbon cloth (e.g. GDL-CT and ELAT) or by pressing carbon fibers together into a carbon paper (e.g. Sigracet, Freudenberg, and Toray). Many of the standard GDLs that are produced today come with a Micro Porous layer (MPL) and hydrophobic treatment (PTFE). The MPL and PTFE help with the contact to the membrane and with water management. The MPL typically provides a smooth layer with plenty of surface area for catalyst and good contact with the membrane. The MPL often uses PTFE as a binder that increases hydrophobicity, which helps keep the water within the membrane from escaping—drying out the membrane and causing higher resistance (lower performance).

Second bipolar plate 14 presses up against the gas diffusion medium 34 on the cathode face 8c of MEA 8 and gas diffusion medium 40 on the anode face 10a of MEA 10, while the first bipolar plate 12 presses up against the gas diffusion medium 36 on the anode face 8a of MEA 8 and against the gas diffusion medium 38 on the cathode face 10c of MEA 10. An oxidant gas such as oxygen or air is supplied to the cathode side of the fuel cell stack from a storage tank 46 via appropriate supply plumbing 42. Similarly, a fuel such as hydrogen is supplied to the anode side of the fuel cell from a storage tank 48 via appropriate supply plumbing 44. In another embodiment, the oxygen tank 46 may be eliminated, and air supplied to the cathode side from the ambient. Likewise, the hydrogen tank 48 may alternatively be eliminated and hydrogen may be supplied to the anode side from a reformer which catalytically generates hydrogen from methanol or a liquid hydrocarbon (e.g., gasoline).

Exhaust plumbing (not shown) for both the H₂ and O₂/air sides of the MEAs may also provide for removing H₂-depleted anode gas from the anode flow field and O₂-depleted cathode gas from the cathode flow field. Coolant plumbing 50, 52 is provided for supplying and exhausting liquid coolant to the bipolar plates 14, 16 as needed. It is understood that each of the inner metal elements 56 of the bipolar plates 12, 14, 16 define flow fields 18 such that a serpentine flow channel may be formed between the inner and outer metal elements 56, 58 for a coolant flow field 20. Moreover, flow fields 18 are also provided in the inner metal element 56 such that the input reactant gas is guided along the surface of the gas diffusion layer 21, 23 for each fuel cell.

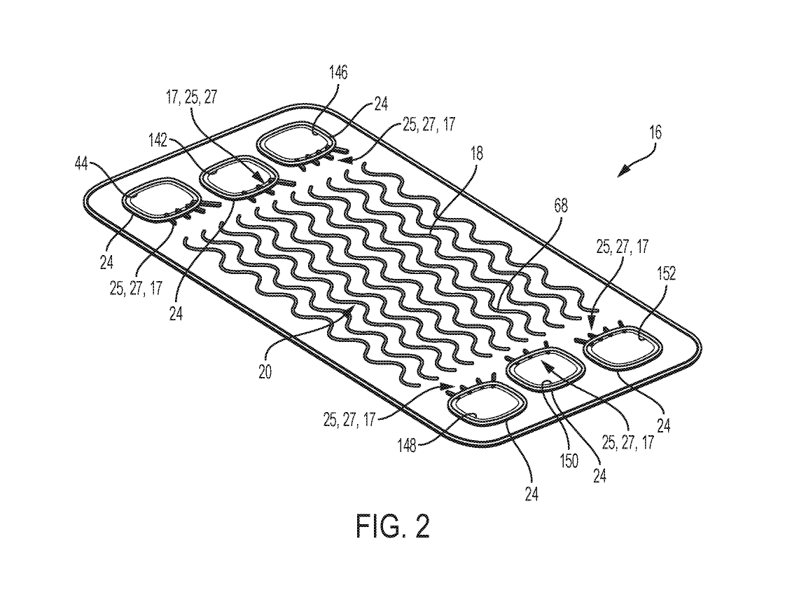

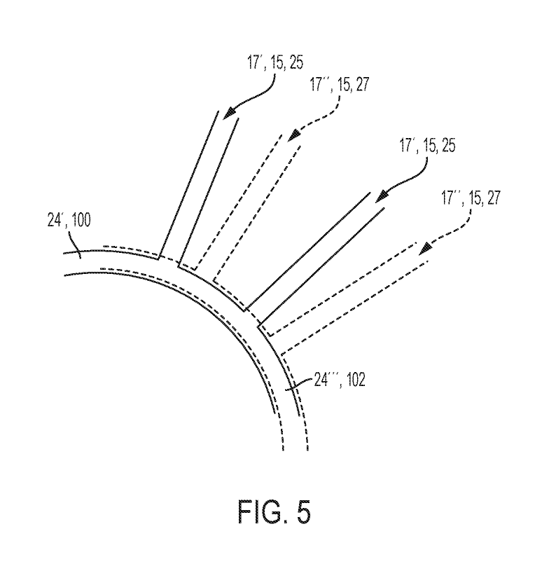

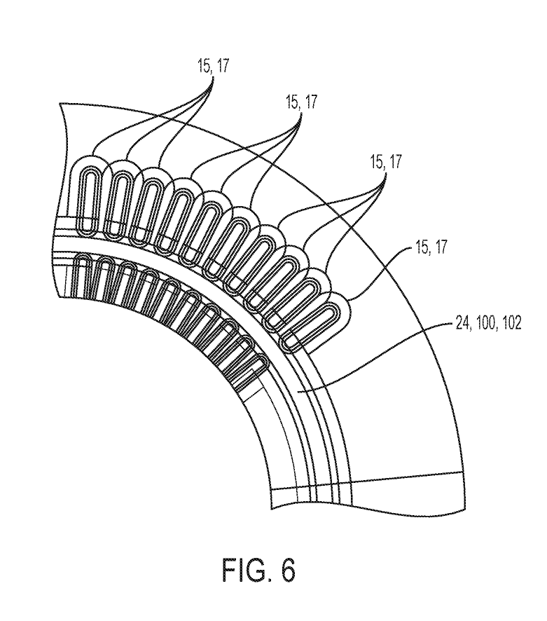

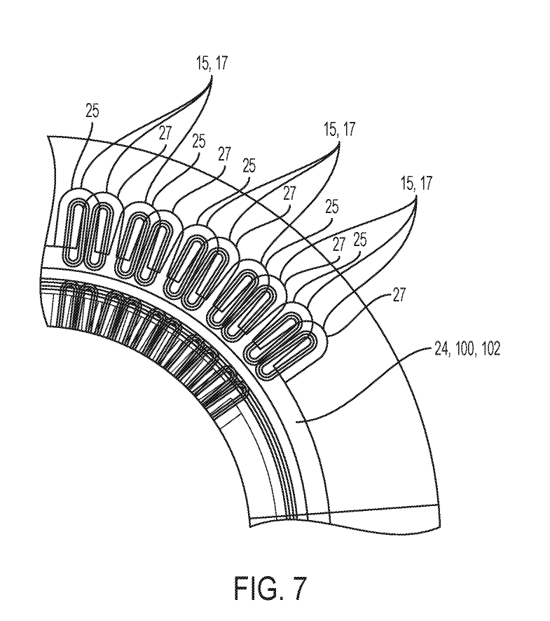

Regardless of the configuration, the first bipolar plate 12 and the second bipolar plate 14 each include at least one embossment 15 formed therein. If embossment 15 is in a first bipolar plate 12, the embossment 15 is a first plate embossment 25. If embossment 15 is in a second bipolar plate 14, then embossment 15 is a second plate embossment 27 (shown in FIGS. 5, 10, and 11). The first and second plate embossments 25, 27 may be in the form of tunnels 17′, 17″ as shown which are substantially perpendicular to their associated metal bead seal 24, (shown in FIGS. 2, 3, 5, and 11) wherein the tunnels 17′, 17″ are spaced along the length of the metal bead seal 24′, 24″. Accordingly, the first bipolar plate 12 may therefore include a first plate embossment 25 which may be a plurality of tunnels 17′ along the length of the first plate metal bead seal 24′, 100 as provided in the foregoing description. The second bipolar plate 14 may therefore similarly also include a second plate embossment 27 which may be formed from a plurality of tunnels 17′ disposed along the length of the second plate metal bead seal 24′, 102 such that the tunnels 17′ in the second plate embossment 27 are either completely offset as shown in FIGS. 5 and 6 (or partially offset as shown in FIG. 7) from the tunnels 17′ of the first plate embossment 25.

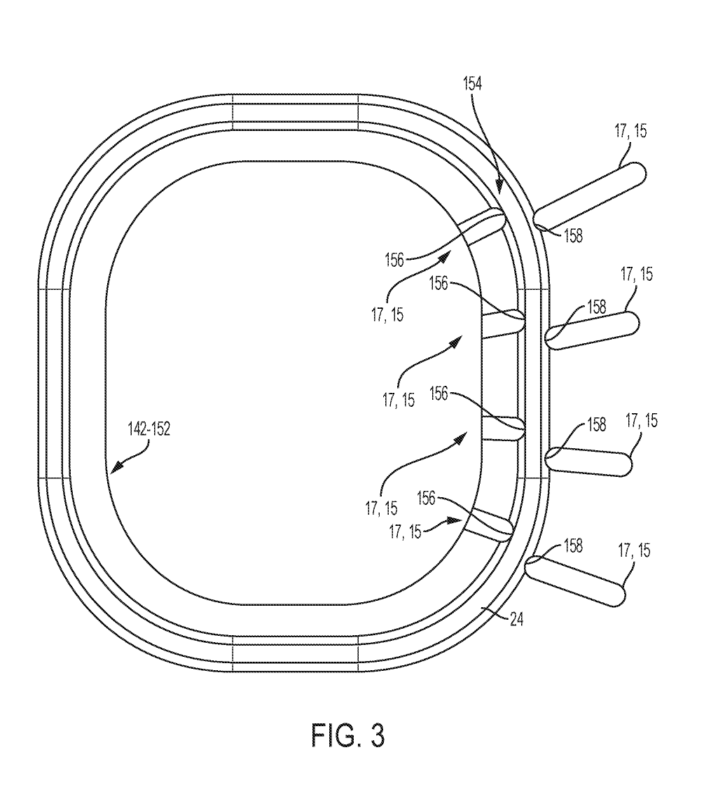

FIG. 2 is a perspective view of a first embodiment of a bipolar plate 16—which may be a first bipolar plate 12 or a second bipolar plate 14. Bipolar plate 16 may define manifold openings 142-152 for introducing or exiting a liquid coolant or reactants to the flow field. In a refinement, as shown in FIG. 3, metal bead 24 surrounds one or more of openings 142-152. First metal bead 24 is an embossment in bipolar plate 16 that defines a first channel 154. Typically, the liquid coolant or reactants flow through this channel 154. In a refinement, a soft material (e.g., elastomer, rubber, foam, etc.) may be coated on the top of metal bead 24 to make a seal between adjacent flow fields.

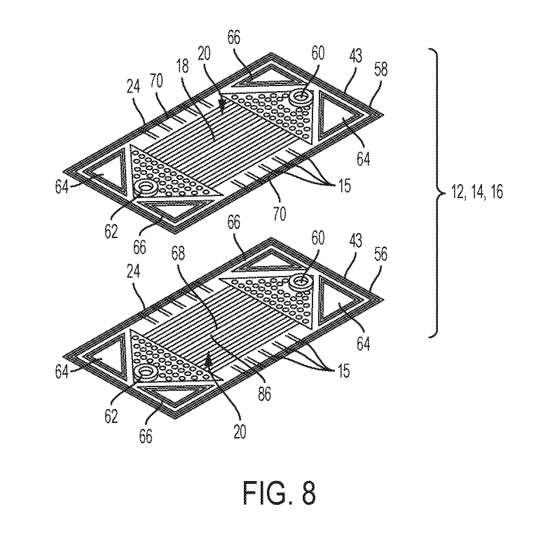

With further reference to FIG. 3, plurality of tunnels 17 provides a passage into and out of the metal bead seal 24. Therefore, tunnels 17′ are in fluid communication with metal bead seal 24. A metal bead seal 24 surrounds each manifold opening 142-152. Metal bead seal 24 is an embodiment that defines a first channel 154. Plurality of tunnels 17 provides a passage into and out of the channel 154. Each tunnel 17 of the embossment 15 has an inlet tunnel section 156 that leads to the first channel 154 and an outlet tunnel section 158 that extends from the first channel 154 to provide a reactant gas or coolant to flow channels 18, 68 (shown in FIGS. 2 and 8).

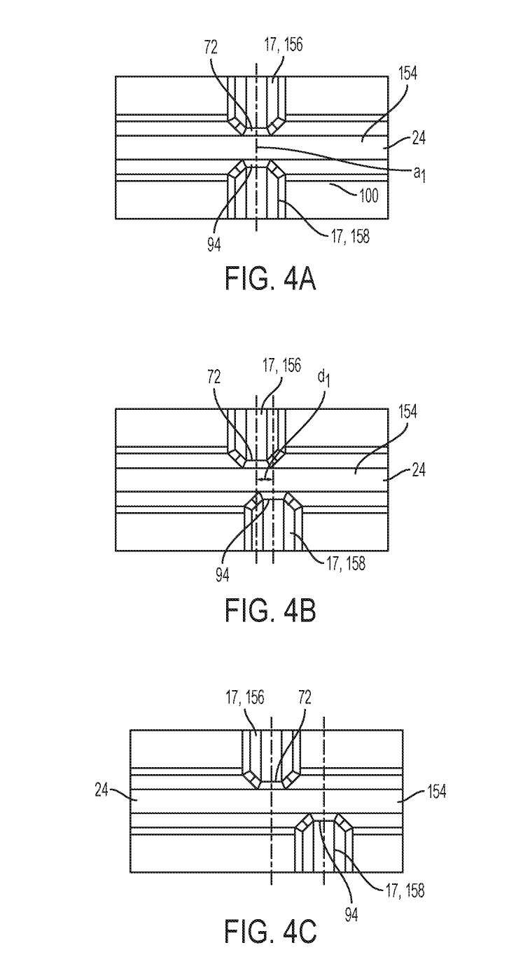

With respect to FIGS. 3, and 4B-4C, schematic, partial illustrations of channel tunnel intersections with varying amounts of offset between inlet tunnel section 156 and outlet tunnel section 158 in the plurality of tunnels 17′ of a bipolar plate are provided. In this context offset means the point of attachment between inlet tunnel section 156 and metal bead seal 24 and the point of attachment between outlet tunnel section 158 and metal bead seal 24 are spatially offset along longitudinal distance d₁ in metal bead seal 24 such that inlet tunnel section 72 and outlet tunnel section 94 do not completely line up. In FIG. 4A, an axis at runs through the centers of both inlet tunnel section 156 and outlet tunnel section 158 so there is zero offset. In FIGS. 4B and 4C, axis a₁ which runs through the center of inlet tunnel section 156 is offset from axis a₂ which runs through the center of outlet tunnel section 158 by an offset distance d₁. FIG. 4B illustrates the case when d₁ is equal to half the average width (the combined average width at the base thereof at the points of intersection with metal bead seal 24′) of inlet tunnel section 156 and outlet tunnel section 158 at their respective bases. It is understood that the cross section of inlet tunnel section 72 and outlet tunnel section may be in various forms such as but not limited to a trapezoidal cross section. U.S. patent application Ser. No. 15/85,795 discloses tunnel sections with curved cross sections and the entire disclosure of this application is hereby incorporated by reference.

While each inlet tunnel section 156 may or may not be aligned with the corresponding outlet tunnel section 158 within a single bipolar plate (as shown in FIGS. 4A-4C), it is understood that the tunnels 17′ (in the form of inlet tunnel sections 156 and outlet tunnel sections 158) in a first bipolar plate 12 may be offset from the tunnels 17′ in the adjacent second bipolar plate 14 as shown in FIGS. 5 and 6. With reference to FIG. 5, the tunnels 17′ in the first bipolar plate are spaced apart and offset from the tunnels 17″ in the second bipolar plate. With reference to FIG. 6, the tunnels 17′ in the first bipolar plate are adjacent to and offset from the tunnels 17″ in the second bipolar plate. As a result of having the tunnels 17′, 17″ offset between adjacent plates, the pressure flow within the metal bead seals 24′, 24″ remains relatively even as the adjacent bipolar plates are stacked together. It is understood that the tunnels 17′, 17″ of any two adjacent plates in a fuel cell stack are offset from each other as shown in FIGS. 5-7, 10, and 11.

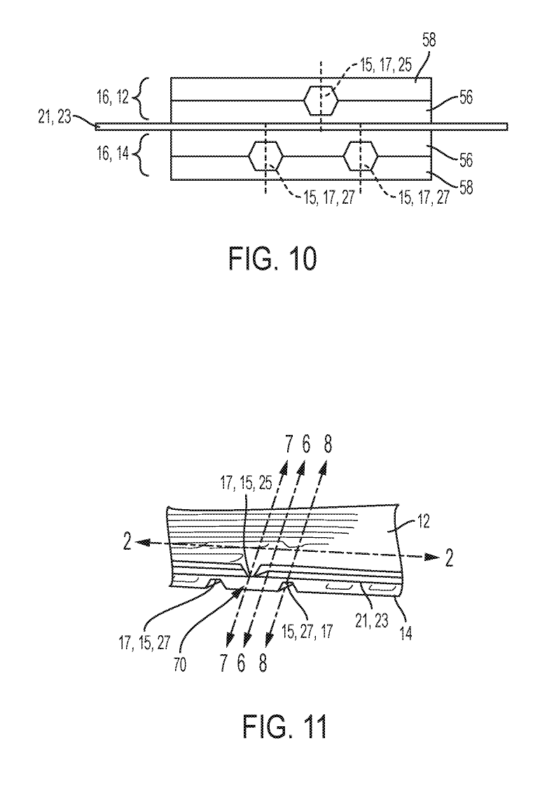

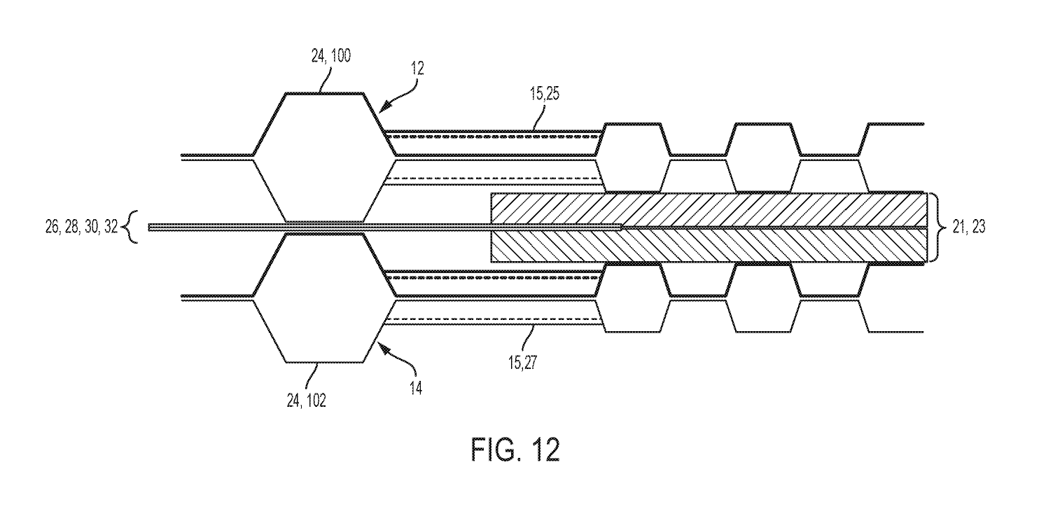

Referring now to FIGS. 8-14, another embodiment of the metal bead seals 24, first plate embossment and second plate embossment are shown where the metal bead seal joint 104 is proximate to the periphery of the bipolar plates 12, 14 (See FIGS. 12-14). It is understood that while bipolar plate 16 is shown in FIG. 8, bipolar plate 16 may be a first bipolar plate 12 or a second bipolar plate 14. It is understood that bipolar plate 16 is formed from two metal elements 56, 58. While bipolar plate 16 may be either a first bipolar plate 12 or a second bipolar plate 14, it is understood that embossment 15 in bipolar plate 16 is offset from an embossment in an adjacent bipolar plate (see FIGS. 10-11). The “inner” metal element 56 which may be disposed proximate to the gas diffusion layer 21, 23 (shown in FIG. 1) includes a first side 86 defining a reactant flow field 18 and a second side 88 defining a coolant flow field 68. The reactant flow field 18 is a predetermined flow field pattern 18 which may be in the form of this example, non-limiting list: wiggled pattern, straight pattern or serpentine pattern. The predetermined flow field pattern may be adjacent to the face of the gas diffusion layer (not shown in FIG. 8). The coolant flow field 68 is defined between the two metal elements 56, 58 for each first and second bipolar plates 12, 14. It is understood that the coolant and reactant flow fields 18, 68 (FIGS. 2 and 8) may configured in a variety of forms. Non-limiting example configurations for the reactant and coolant flow fields 18, 68 may be a serpentine path schematically shown in FIG. 1 or shown wavy as shown in FIG. 2 or may be multiple parallel channels as shown in FIG. 8.

As indicated, in FIG. 8, metal elements 56, 58 of a non-limiting example bipolar plate 12, 14, 16 are shown. Inner metal element 56 attaches to the outer metal element 58 to define the coolant flow path 68 (shown in FIG. 2). Also, at least one metal element may define an embossment 15 (in the form of a plurality of tunnels) or open cavities/recesses 17 which are in communication with the associated metal bead seal 24 in the same bipolar plate 16. Again, the associated metal bead seal 24 in the present, non-limiting embodiment is defined proximate to the periphery of each bipolar plate 16 as shown in FIG. 8. The embossment 15 (in the form of a plurality of tunnels 17) shown may be a first plate embossment or a second plate embossment. It is also understood that the embossment 15 may extend along at least a portion of the lateral length of the outer metal bead seal as shown in FIG. 8 or along the entire length of the outer metal bead seal. It is also understood that the embossment 15 may also include formations which are around the fuel and oxidant manifold holes 64, 66 (as described earlier in FIGS. 2-7) where the embossment 15, 25, 27 (tunnels 17) are in communication with the metal bead seal 24, 100, 102 around those manifold holes 142-152.

Referring to FIG. 8, fuel manifold holes 64 (for Hydrogen) are provided for supply and removal. Oxidant manifold holes 66 (for Oxygen) are also provided for supply and removal. While the manifold holes shown in FIG. 8 are shown as triangles, the manifold holes may be round, rectangular or any shape as shown in FIG. 2. Fuel manifold seal areas and oxidant manifold seal areas are at the periphery of the fuel manifold holes and the oxidant manifold holes 66 as shown. The manifold seal areas may extend in a substantially perpendicular direction from the surface of the inner/outer metal element 56, 58 in order to provide contact with the corresponding MEA (shown as elements 8, 10 in FIG. 1). Oxidant manifold holes 66 provide oxidant flow only to and from the cathode chamber.

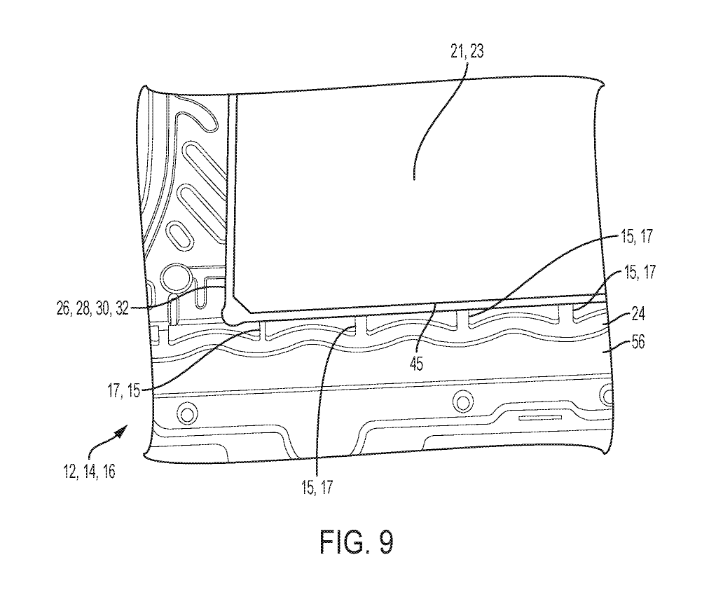

Referring now to FIG. 9, a plan view of another non-limiting example of one of the first or second bipolar plate 12, 14, 16 in accordance with the present disclosure is shown. The gas diffusion layer 21, 23 and sub-gasket 26, 28, 30, 32 are disposed on the corresponding bipolar plate 12, 14, 16 having a wavy metal bead seal 24 (instead of a straight metal bead seal). The embodiment shown in FIG. 9 therefore includes a wavy metal bead seal 24 with an embossments 15 in the form of a plurality of tunnels 17 in communication with the wavy metal bead seal 24. Again, when the bipolar plates 16 are stacked together, it is understood that tunnels 17 in a first bipolar plate 12 are offset from tunnels 17 in an adjacent bipolar plate 14 as shown in FIGS. 10 (side view) and 11 in order to provide for substantially even pressure throughout the metal bead seal given that the metal bead seal for each bipolar plate 12, 14 is not subjected to concentrated pressure at specific points—given that the tunnels in adjacent bipolar plates do not exert direct pressure on one another. The embossments 15 (which may have various configurations) of the bipolar plate 12, 14, 16 may be in the form of tunnels 17 which are in fluid communication with the metal bead seal.

Referring now to FIGS. 10-11, partial, schematic cross-sectional views of a various non-limiting examples of the offset tunnels of a PEM fuel cell of the present disclosure are shown. The metal bead seal is removed from FIGS. 10 and 11 in order to show the first plate embossment (tunnels 17) and the second plate embossment (tunnels) which are offset from one another. Accordingly, pressure in each metal bead seal 24 for both the first and second bipolar plates remains fairly even when the bipolar plates are stacked together given that the tunnels 17 (which support the associated metal bead seal) in adjacent bipolar plates 16 are offset. In view of even pressure distribution at the metal bead seal joint 104, the fuel cell of the present disclosure provides for reduced risk of leakage of reactant.

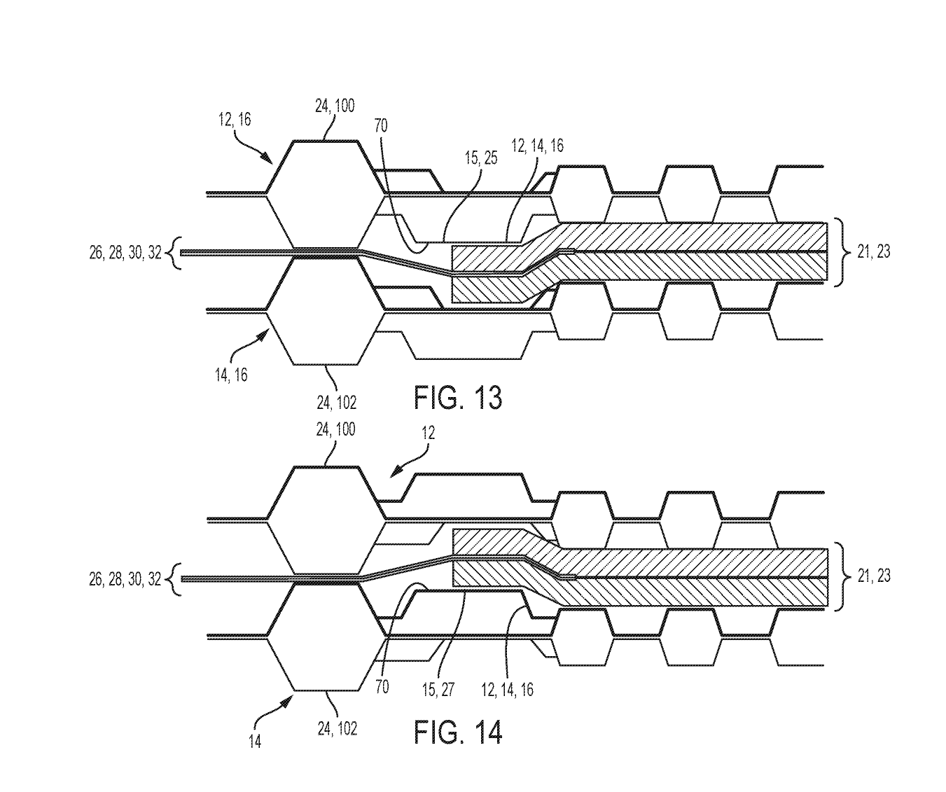

Accordingly, as described above, a fuel cell 120 is provided which includes a first bipolar plate 12, a second bipolar plate 16, first and second sub-gaskets 30, 32 (shown in FIG. 1) and a gas diffusion layer 21, 23. The second bipolar plate 14 defines a second plate metal bead seal and a second plate embossment which is in fluid communication with the second plate metal bead seal. The first bipolar plate 12 defines a first plate metal bead seal 100 and a first plate embossment 25 which is in fluid communication with the first plate metal bead seal 100. The gas diffusion layer 23 may be disposed between the corresponding first and second bipolar plates 12, 14. The first and second plate embossments 25, 27 may, but not necessarily, be tunnels 17 (as shown in FIGS. 5, 12, 14) which are formed in each of the first and second bipolar plates 12, 14. The tunnels 17 may have varying length. However, some or each tunnel 17 may be vertically shortened such that the tunnel 17 does not interfere with the gas diffusion layer 21, 23. However, in the event that the tunnels 17 are not vertically shortened, the tunnels 17 may adjust the position of the gas diffusion layer 21, 23 where such interference may occur—as shown in FIGS. 13 and 14.

It is also understood that the tunnels (or tunnel embossments) 17 may be partially offset (shown in FIG. 7) or completely offset (shown in FIG. 5) as the tunnels 17′, 17″ for each bipolar plate extend away from each corresponding metal bead seal 24, 24′.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A fuel cell comprising:
a first bipolar plate defining a first plate metal bead seal and a first plate embossment in fluid communication with the first plate metal bead seal; and
a second bipolar plate defining a second plate metal bead seal and a second plate embossment in fluid communication with the second plate metal bead seal, the second plate metal bead seal being operatively configured to form a joint with the first plate metal bead seal, wherein the second plate embossment is offset from the first plate embossment.

2. The fuel cell of claim 1 wherein the second plate embossment is formed by a plurality of tunnels disposed along at least a portion of the length of the second plate metal bead seal.

3. The fuel cell of claim 1 wherein the first plate embossment is formed by a plurality of tunnels disposed along at least a portion of the length of the first plate metal bead seal.

4. The fuel cell of claim 1 wherein first and second plate metal bead seals are disposed proximate to the periphery of the fuel cell.

5. The fuel cell of claim 1 wherein the first and second plate metal bead seals are defined around a fuel manifold.

6. The fuel cell of claim 1 wherein the first and second plate metal bead seals are defined around an oxidant manifold.

7. A fuel cell comprising:
a first bipolar plate defining a first plate metal bead seal and a first plate embossment in fluid communication with the first plate metal bead seal; and
a second bipolar plate defining a second plate metal bead seal and a second plate embossment in fluid communication with the second plate metal bead seal, the second plate metal bead seal being operatively configured to form a joint with the first plate metal bead seal, wherein the second plate embossment is partially offset from the first plate embossment.

8. The fuel cell of claim 7 wherein the second plate embossment is formed by a plurality of tunnels disposed along at least a portion of the length of the second plate metal bead seal.

9. The fuel cell of claim 7 wherein the first plate embossment is formed by a plurality of tunnels disposed along at least a portion of the length of the first plate metal bead seal.

10. The fuel cell of claim 7 wherein first and second plate metal bead seals are disposed proximate to the periphery of the fuel cell.

11. The fuel cell of claim 7 wherein the first and second plate metal bead seals are defined around a fuel manifold.

12. The fuel cell of claim 7 wherein the first and second plate metal bead seals are defined around an oxidant manifold.

13. A fuel cell comprising:
a first bipolar plate defining a first metal bead seal and a first plate embossment in fluid communication with the first metal bead seal;
a second bipolar plate defining a second metal bead seal and a second plate embossment in fluid communication with the second metal bead seal, the second metal bead seal operatively configured to abut the first metal bead seal to form a joint; and
a gas diffusion layer disposed between the first bipolar plate and the second bipolar plate.

14. The fuel cell of claim 13 wherein the first and second plate embossments include a plurality of nesting tunnels in each of the first and second bipolar plates.

15. The fuel cell of claim 13 wherein each of the first and second bipolar plates further comprises a metal element having a first side defining a reactant flow field and a second side defining a coolant flow field.

16. The fuel cell of claim 14 wherein each tunnel is substantially perpendicular to the metal bead seal.
